(19) United States
(12) Patent Application Publication
(10) Pub. No.: US 2007/0035124 A1
(43) Pub. Date: Feb. 15, 2007

(54) Plumbing fitting housing

(76) Inventor: Christopher Withers, Wallaceville (NZ)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 11/482,631

(22) Filed: Jul. 7, 2006

(30) Foreign Application Priority Data
Jul. 8, 2005 (NZ) 541172

(51) Int. Cl. F16L 3/00

(52) U.S. Cl. 285/64

(57) ABSTRACT

A plumbing fitting housing to be mounted in a hole in a wall has a water receiving portion, and a collar extending from the water receiving portion. The collar is configured to be placed through the hole in the wall. The plumbing fitting housing has a socket having a socket wall configured to be placed through the hole in a wall and receive the collar, and a flange extending radially outward from an end of the socket wall for sealing engagement with the wall. A drainage passage is formed by the water receiving portion, the collar and the socket.

### CROSS REFERENCE TO RELATED APPLICATIONS

The application claims the benefit of and priority to New Zealand Patent Application No. 541172 filed Jul. 8, 2005, the entire disclosure of which is herein incorporated by reference.

### BACKGROUND

The invention relates to a plumbing fitting housing to collect water dripping or leaking from a plumbing fitting.

Plumbing fittings such as shower mixers or taps for sinks and baths are typically fixed to the interior framing of a wall. A hole is cut in the wall and the plumbing fitting extends through the wall to the interior of the room. The plumbing fittings are typically connected to pipes through additional fittings and fixtures. It is common for water to leak or drip from these connection points. As the connection points are behind the wall lining and inside the wall cavity, any water that leaks or drips will land on the framing and wall surfaces surrounding the plumbing fitting. The water becomes trapped and cannot easily escape. This can lead to damage to the material and structure of the house. A side effect of leaking buildings is the risk to human health. Some moulds that grow on damp timber and other materials can cause respiratory and skin problems.

It is an object of the invention to provide a plumbing fitting housing for collecting water leaking or dripping from a plumbing fitting and remove the water from the wall cavity, and/or to at least provide the public with a useful alternative.

### SUMMARY OF THE INVENTION

In one aspect, the invention broadly consists in a plumbing fitting housing to be mounted in a hole in a wall, the housing comprising:

a water receiving portion,

a collar extending from the water receiving portion, the collar adapted to be placed through the hole in a wall;

a seal for sealing the housing to the wall; and

a drainage passage formed by the water receiving portion, the collar and the seal.

Preferably, the seal comprises a socket for supporting the housing in the wall.

Preferably, the socket has a flange for sealing engagement with the wall.

Preferably, the water receiving portion surrounds a portion of the plumbing fitting.

Preferably, the water receiving portion surrounds at least a portion of the plumbing fitting.

Preferably, the water receiving portion comprises a cup portion having a back plate with a perimeter and a cup wall extending around a major portion of the perimeter.

Preferably, the perimeter of the back plate is substantially circular and the cup wall is a substantially annular wall extending around a major portion of the perimeter.

Preferably, the collar is formed integrally with the water receiving portion.

Preferably, the seal comprises a socket having a socket wall configured to receive the collar and a flange extending radially outward from an end of the socket wall for sealing engagement with the wall. More preferably, the socket wall is a substantially annular wall.

Preferably, the socket further has a plate covering or enclosing the end of the socket. More preferably, the front plate has perforations.

In a second aspect, the invention broadly consists in a plumbing fitting housing to be mounted in a hole in a wall, the housing comprising:

a water receiving portion,

a collar extending from the water receiving portion, the collar configured to be placed through the hole in a wall;

a socket having a socket wall configured to be placed through the hole in a wall and receive the collar, and a flange extending radially outward from an end of the socket wall for sealing engagement with the wall; and

a drainage passage formed by the water receiving portion, the collar and the socket.

In a third aspect, the invention broadly consists in the combination of the plumbing fitting housing of the first or second aspect and a plumbing fitting, wherein the water receiving portion surrounds the plumbing fitting.

Preferably, in the combination of the third aspect, the plumbing fitting has an inlet extending through an inlet slot or aperture in the collar.

Preferably, in the combination of the third aspect, the plumbing fitting has at least one outlet extending through an outlet slot or aperture in the collar.

In a fourth aspect, the invention broadly consists in a method of installing a plumbing fitting housing, the method comprising:

providing an aperture through a wall;

providing a plumbing fitting housing, the plumbing fitting housing comprising a water receiving portion, a collar extending from the water receiving portion, the collar adapted to be placed through the hole in a wall, a seal for sealing the housing to the wall, and a drainage passage formed by the water receiving portion, the collar and the seal;

placing the plumbing fitting housing in the aperture with the collar extending through the aperture and the plumbing fitting housing surrounding a portion of the plumbing fitting.

Preferably, in the method of the third aspect, the seal is a socket and the method further comprises placing the socket through the aperture such that the socket extends through the aperture and surrounds the collar.

The term ‘comprising’ as used in this specification and claims means ‘consisting at least in part of’, that is to say when interpreting independent claims including that term, the features prefaced by that term in each claim all need to be present but other features can also be present.

### BRIEF DESCRIPTION OF THE DRAWINGS

The present invention will now be described with reference to the accompanying drawings in which:

FIG. 1 is a perspective view of the housing of the first preferred embodiment;

FIG. 2 is a top view of the housing of the first preferred embodiment;

FIG. 3 is a side view of the housing of the first preferred embodiment;

FIG. 4 is a front view of the housing of the first preferred embodiment;

FIG. 5 is a back view of the housing of the first preferred embodiment;

FIG. 6 is a perspective view of the socket of the first preferred embodiment;

FIG. 7 is a top view of the socket of the first preferred embodiment;

FIG. 8 is a side view of the socket of the first preferred embodiment;

FIG. 9 is a front view of the socket of the first preferred embodiment;

FIG. 10 is a back view of the socket of the first preferred embodiment;

FIG. 11 is a perspective view from the front of the housing and socket of the first preferred embodiment;

FIG. 12 is a view from the back of the housing and socket of the first preferred embodiment;

FIG. 13 is a top view of the housing and socket of the first preferred embodiment;

FIG. 14 is a side view of the housing and socket of the first preferred embodiment;

FIG. 15 is a back view of the housing and socket of the first preferred embodiment;

FIG. 15a is a cross section taken through line A-A of FIG. 15;

FIG. 15b is a detail view of B of FIG. 15a;

FIG. 16 is a perspective view of the housing of the second preferred embodiment;

FIG. 17 is a top view of the housing of the second preferred embodiment;

FIG. 18 is a side view of the housing of the second preferred embodiment;

FIG. 19 is a back view of the housing of the second preferred embodiment;

FIG. 20 is a perspective view of the socket of the second preferred embodiment;

FIG. 21 is a top view of the socket of the second preferred embodiment;

FIG. 22 is a side view of the socket of the second preferred embodiment;

FIG. 23 is a back view of the socket of the second preferred embodiment;

FIG. 24 is a perspective view from the front of the housing and socket of the second preferred embodiment;

FIG. 25 is a perspective view from the back of the housing and socket of the second preferred embodiment;

FIG. 26 is a top view of the housing and socket of the second preferred embodiment;

FIG. 27 is a side view of the housing and socket of the second preferred embodiment;

FIG. 28 is a back view of the housing and socket of the second preferred embodiment;

FIG. 28a is a cross section taken through line C-C of FIG. 28;

FIG. 28b is a detail view of D of FIG. 28a;

FIG. 29 is a perspective view of the housing of the second preferred embodiment being fixed to a wall framing;

FIG. 30 is a perspective view of a plumbing fitting being fitted in the housing of the second preferred embodiment;

FIG. 31 is a front view of the housing of the first preferred embodiment on the left and the housing of the second preferred embodiment on the right; and

FIG. 32 is a front view of the housing and socket of the first preferred embodiment on the left and the housing and socket of the second preferred embodiment on the right.

### DETAILED DESCRIPTION

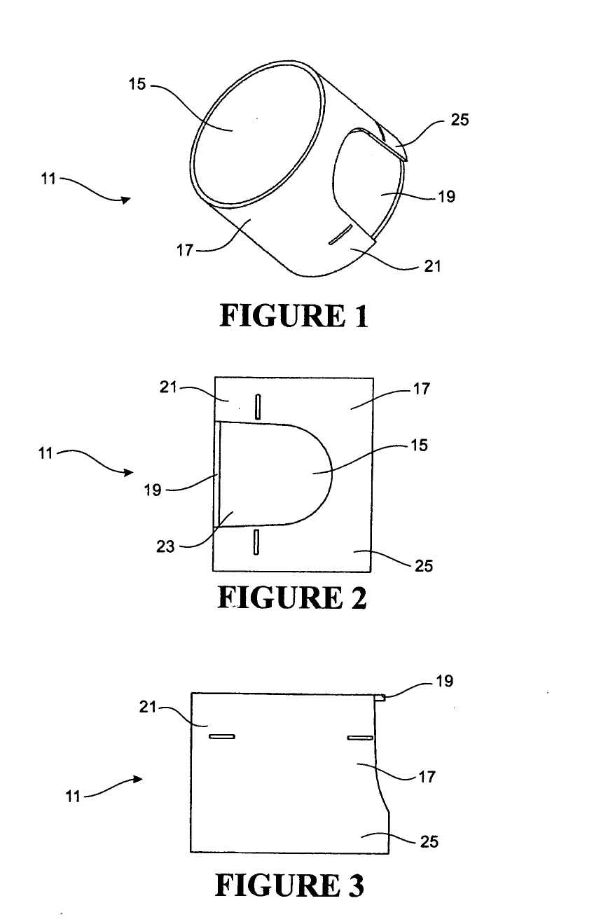

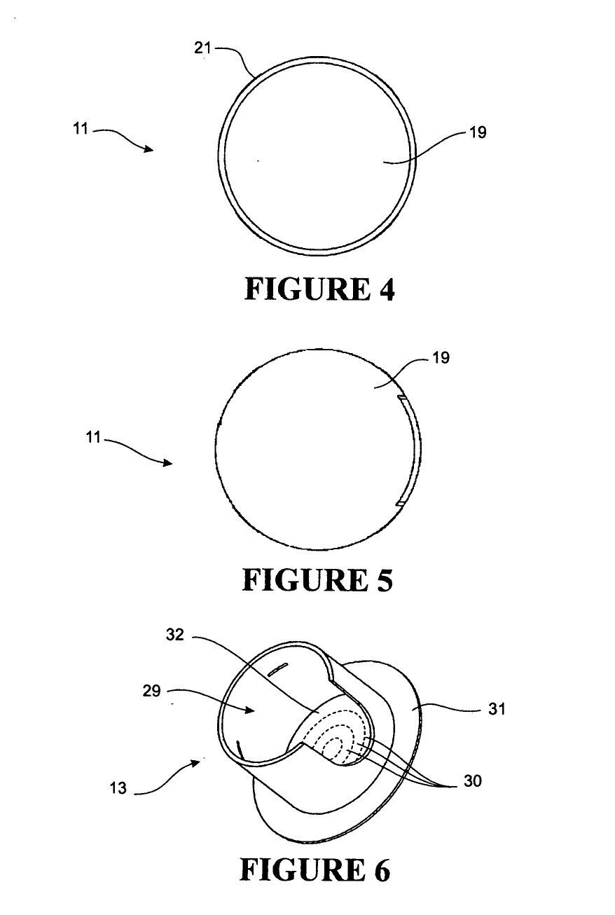

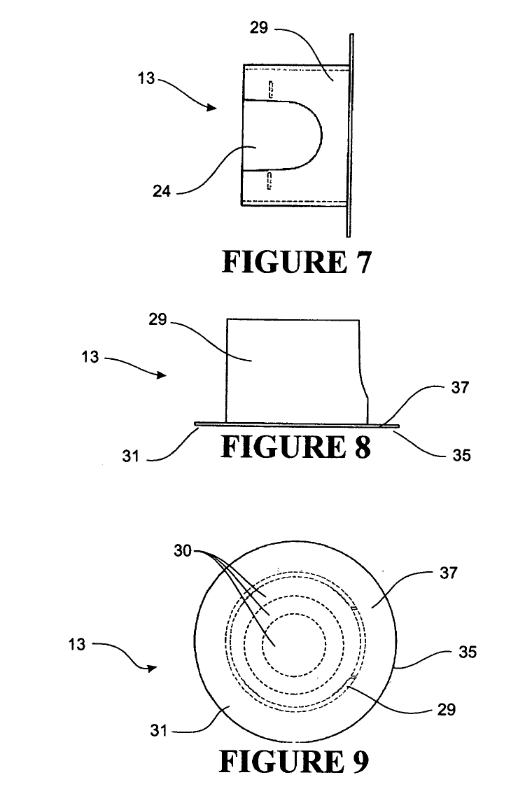

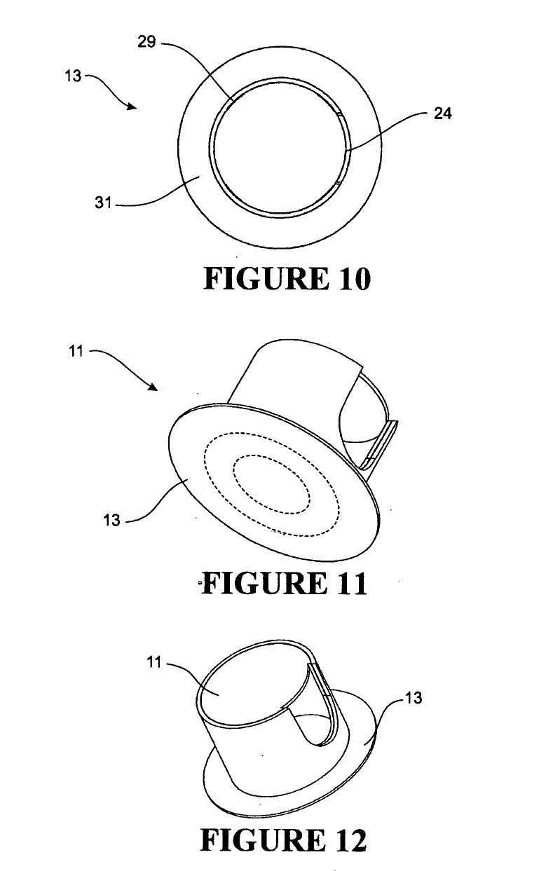

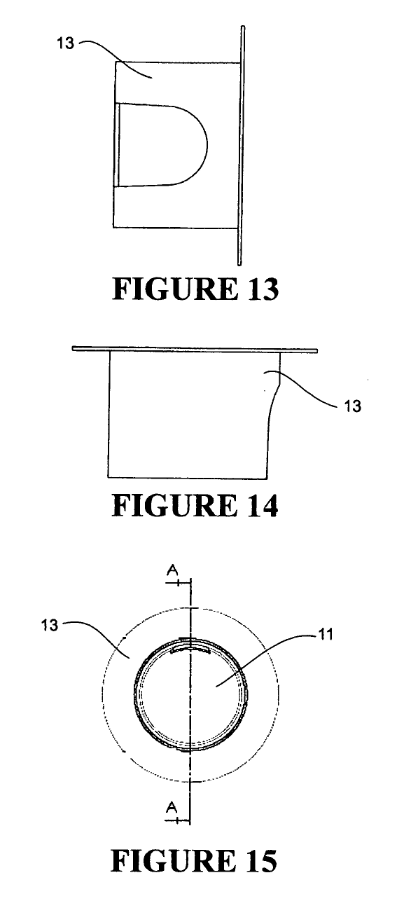

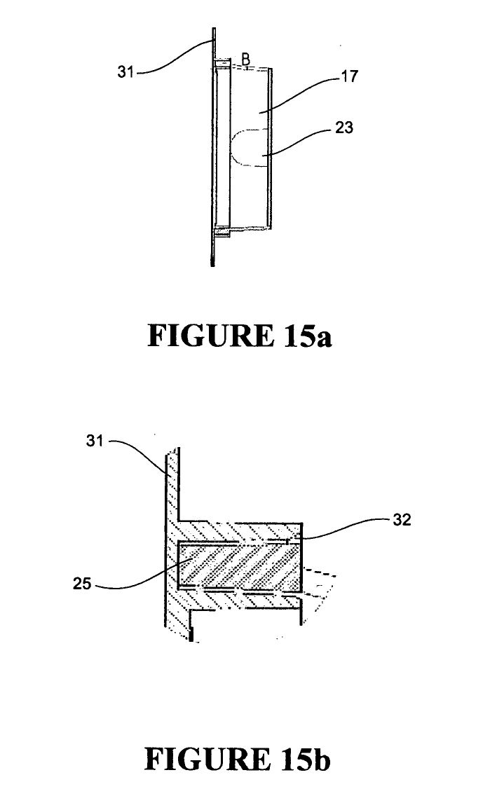

Referring to FIGS. 1 to 15, there is shown a first preferred embodiment plumbing fitting housing. In the embodiment shown, the plumbing fitting housing is adapted for use with a conventional shower mixer. The shower mixer and plumbing fitting housing are positioned in a hole in a wall (not shown) and are fixed to framing behind the wall.

The plumbing fitting housing 11 defines an interior space 15 for receiving water that drips or leaks from the plumbing fitting. The space is defined by a cup portion 17 having a circular back wall 19 and an annular side wall 21. The side wall extends at a right angle from the circumference of the back wall.

When installed, the housing 11 surrounds the shower mixer and is dimensioned and shaped to fit around the mixer. The side wall has apertures or slots 23 to allow space for the pipes connected to the plumbing fitting.

The housing has a collar 25 for supporting the housing in a hole in the wall. The collar extends away from the cup portion 17 and through the wall, when installed. In the embodiment shown, the collar is formed integrally with the cup portion.

A drainage passage is formed by the collar 25 and the cup portion 17. The cup portion, drainage passage, and collar are formed with smooth surfaces to encourage any collected water to follow the passage and drain away. When installed, any collected water will flow from the cup portion through the collar and over the socket into the shower.

The socket 13 has a sleeve 29, a plate 28, and a flange 31 extending radially outward away from one end 33 of the sleeve. The sleeve is circular in cross section. The interior dimension of the sleeve corresponds to the outer dimension of the collar of the housing. The socket has apertures 24 corresponding to apertures 23 of the housing.

The plate 28 covers the end of the sleeve and is manufactured with a number of perforated portions 30. This allows an installer to cut out the central portion of the plate to create an aperture. The aperture size and/or shape is selected by the installer depending upon the type of shower mixer or plumbing fitting. Alternatively, the socket may be manufactured with the aperture pre-formed.

The socket ensures a seal between the wall lining and the plumbing fitting housing. The sleeve of the socket is formed with a slot 32 for receiving the collar 25. The flange 31 may be feathered at its peripheral edge 35 to form a smooth join with the interior wall. The flange may have a sealing portion 37 for sealing the flange and the wall. The sealing portion may have a groove or recess (not shown) for receiving an O-ring. Alternatively, a sealant or gasket may be used between the flange and the wall.

When installed, the socket is positioned so that the flange is against the wall surface with the sleeve extending through the wall. The collar of the housing is supported by the socket and the cup portion surrounds the lower portion of the shower mixer.

The housing and socket are preferably injection moulded from a suitable plastic material, such as ABS. In a preferred embodiment, the socket is formed from a substantially transparent material. The housing and socket may be formed as two separate components or may be integrally formed.

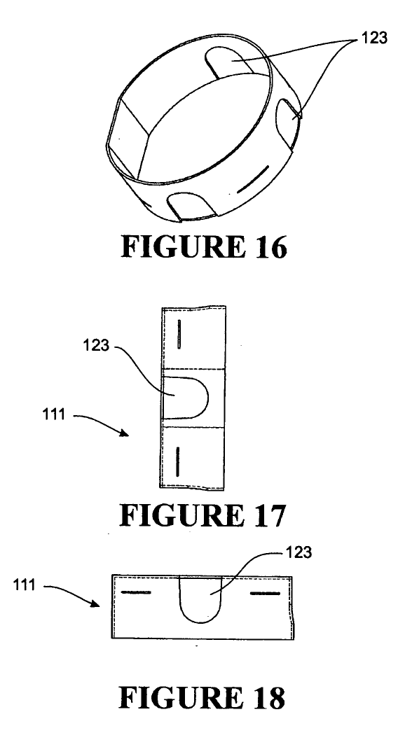

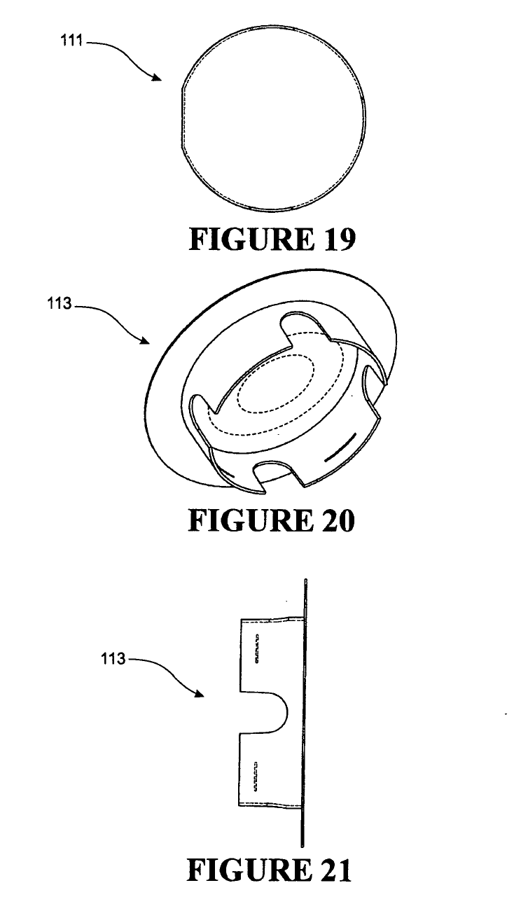

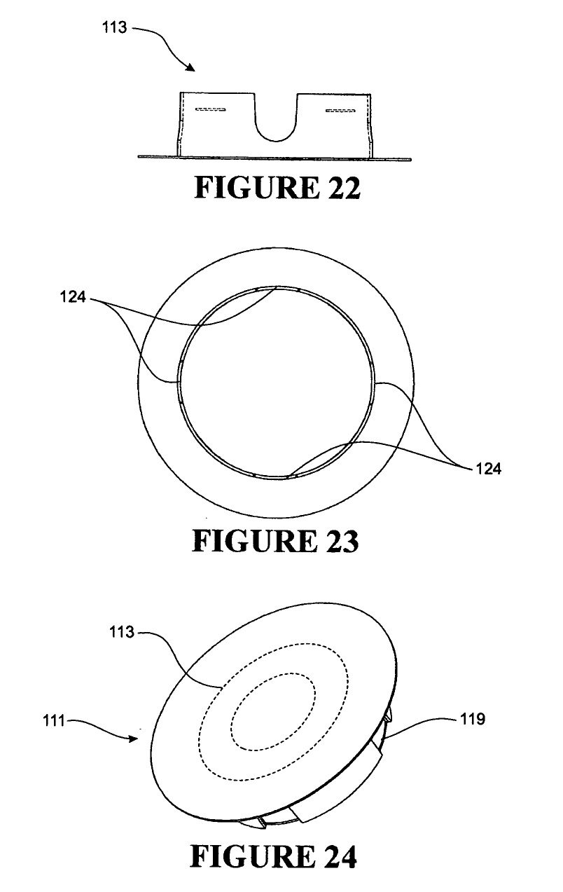

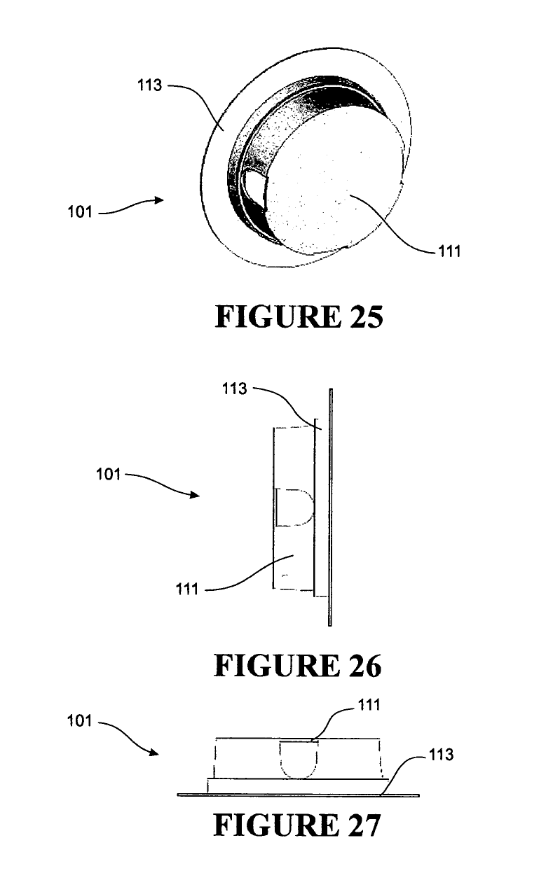

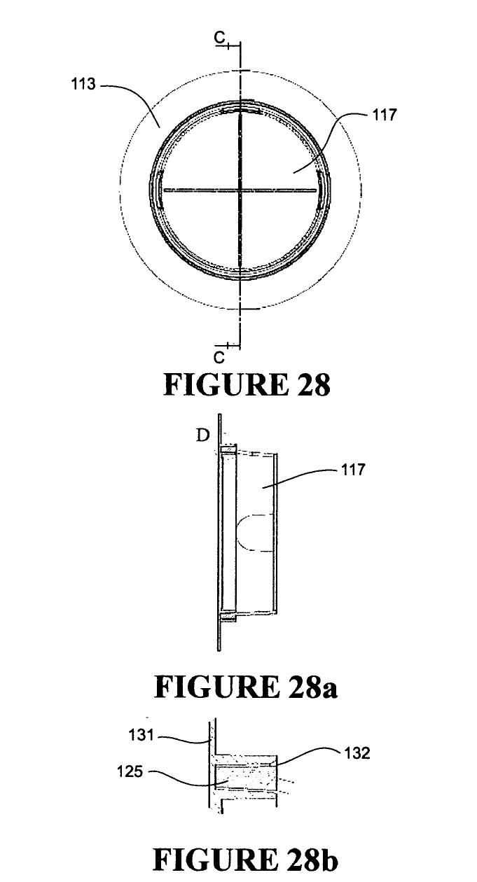

A second preferred embodiment plumbing fitting housing is shown in FIGS. 16 to 28. Unless described below, the features and operation should be considered to be the same as those described above and like numerals are used to indicate like parts, with the addition of 100.

The second embodiment has a cup portion 117 having a circular back wall 119 and an annular side wall 121. The side wall has apertures or slots 123 to allow space for the pipes connected to the plumbing fitting. As for the first embodiment, the second embodiment has a socket 113 for attachment to the collar of the housing.

The second preferred embodiment plumbing fitting housing 111 differs in that the housing has three apertures 123 to allow for the supply pipes of the mixer. The socket 113 has four corresponding apertures 124. It will be appreciated that more or less slots or apertures may be provided if required.

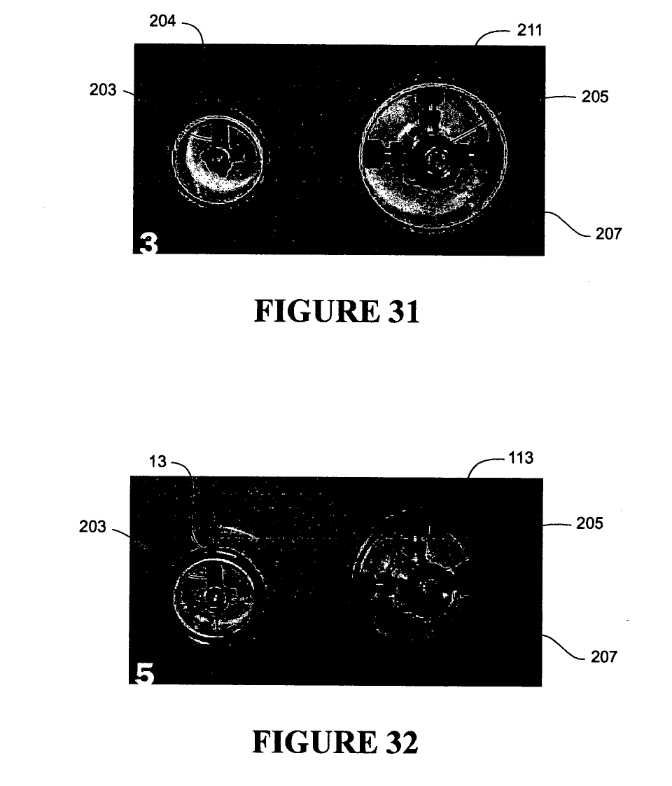

With reference to FIGS. 30 to 32, a preferred method of installation will now be described. The plumbing fitting housing is fixed to the framing 201 at the appropriate height. The housing is attached to the timber framing using fasteners, such as screws or adhesive. The plumbing fitting 203 or 205 is placed inside the cup portion and secured using screws. The wall is lined with plaster board 207 and nailed to the framing. The wall will be sealed and tiled using conventional methods. A hole 209 or 211 through the plasterboard exposes the shower mixer.

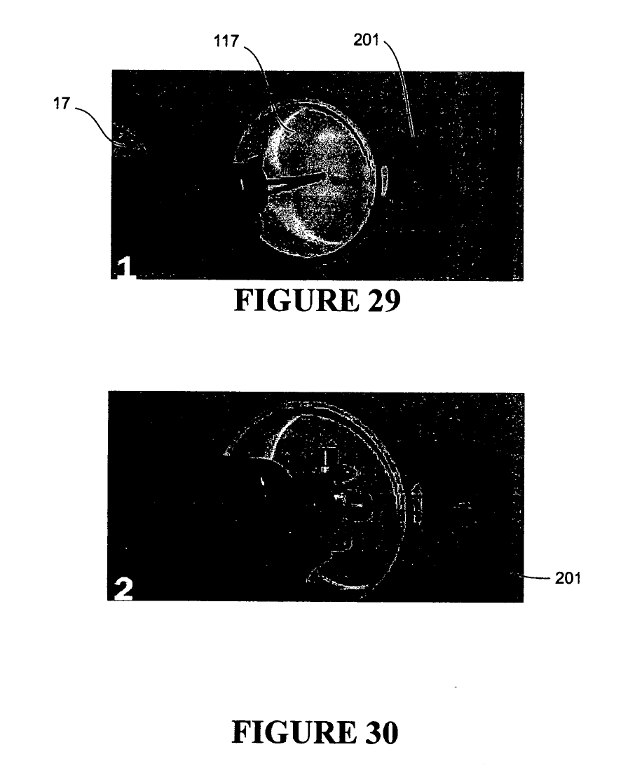

The socket 13 is placed in the hole so that it surrounds and supports the collar 25 of the housing. The sleeve of the socket is formed with a slot 32 for receiving the collar 25. The slot is filled with an appropriate sealant prior to assembly with the collar. The socket is positioned so that the back surface of the flange 33 is sealed against the wall lining. The flange is attached to the wall using adhesive, or a snap fit between the collar 25 and the sleeve of the socket. In FIGS. 29 to 32 the socket is transparent allowing the plumbing fitting and cup portion to be visible.

A sealant may be provided between the flange and the wall lining before the socket is placed in the wall. Alternatively, an O-ring may be provided between the flange and the wall lining.

The above describes preferred embodiments of the present invention, and modifications may be made thereto without departing from the scope of the claims.

The plumbing fitting housing has been described as surrounding the plumbing fixture when installed. Alternatively, the housing may surround the lower portion of the plumbing fixture.

The plumbing fitting housing has been described for use with a shower mixer. However, it will be appreciated that the plumbing fitting housing may be used with other plumbing fittings that extend through a wall, for example a tap.

The plumbing fitting housing has been described for use with tiled showers. Alternatively, the plumbing fitting housing may be installed in conventional acrylic shower units.

The plumbing fitting housing has been described as a cup portion having a semicircular back wall and a side wall. Alternatively, the cup portion may have a conical or funnel shape.

The plumbing fitting housing and socket have been described as circular when viewed from the front. Alternatively, these components may have other shapes, for example, square or elliptical.

The foregoing describes embodiments of the invention including preferred forms thereof. Modifications and improvements as would be obvious to those skilled in the art are intended to be incorporated within the scope hereof, as defined by the accompanying claims.

1. A plumbing fitting housing to be mounted in a hole in a wall, the housing comprising:
a water receiving portion,
a collar extending from the water receiving portion, the collar adapted to be placed through the hole in a wall;
a seal for sealing the housing to the wall; and
a drainage passage formed by the water receiving portion, the collar and the seal.

2. A plumbing fitting housing as claimed in claim 1, wherein the water receiving portion surrounds at least a portion of the plumbing fitting.

3. A plumbing fitting housing as claimed in claim 1, wherein the water receiving portion comprises a cup portion having a back plate with a perimeter and a cup wall extending around a major portion of the perimeter.

4. A plumbing fitting housing as claimed in claim 3, wherein the perimeter of the back plate is substantially circular and the cup wall is a substantially annular wall extending around a major portion of the perimeter.

5. A plumbing fitting housing as claimed in claim 1, wherein the collar is formed integrally with the water receiving portion.

6. A plumbing fitting housing as claimed in claim 1, wherein the seal comprises a socket having a socket wall configured to receive the collar and a flange extending radially outward from an end of the socket wall for sealing engagement with the wall.

7. A plumbing fitting housing as claimed in claim 6, wherein the socket further has a plate covering or enclosing the end of the socket.

8. A plumbing fitting housing as claimed in claim 7, wherein the front plate has perforations.

9. A plumbing fitting housing as claimed in claim 6, wherein the socket wall is a substantially annular wall.

10. A plumbing fitting housing to be mounted in a hole in a wall, the housing comprising:
a water receiving portion,
a collar extending from the water receiving portion, the collar adapted to be placed through the hole in a wall;
a socket having a socket wall configured to receive the collar, and a flange extending radially outward from an end of the socket wall for sealing engagement with the wall; and
a drainage passage formed by the water receiving portion, the collar and the socket.

11. The combination of the plumbing fitting housing as claimed in claim 10, and a plumbing fitting, wherein the water receiving portion surrounds the plumbing fitting.

12. The combination as claimed in claim 11, wherein the plumbing fitting has an inlet extending through an inlet slot or aperture in the collar.

13. The combination as claimed in claim 11, wherein the plumbing fitting has at least one outlet extending through an outlet slot or aperture in the collar.

14. A method of installing a plumbing fitting housing, the method comprising:
providing an aperture through a wall;
providing a plumbing fitting housing, the plumbing fitting housing comprising a water receiving portion, a collar extending from the water receiving portion, the collar adapted to be placed through the hole in a wall, a seal for sealing the housing to the wall, and a drainage passage formed by the water receiving portion, the collar and the seal;
placing the plumbing fitting housing in the aperture with the collar extending through the aperture and the plumbing fitting housing surrounding a portion of the plumbing fitting.

15. The method as claimed in claim 14, wherein the seal is a socket and the method further comprises placing the socket through the aperture such that the socket extends through the aperture and surrounds the collar.
